(19) United States
(12) Patent Application Publication
(10) Pub. No.: US 2021/0390607 A1
(43) Pub. Date: Dec. 16, 2021

(54) METHOD, APPARATUS AND COMPUTER PROGRAM FOR STYLE RECOMMENDATION

(71) Applicant: ODD CONCEPTS INC., Seoul (KR)

(72) Inventor: Tae Young JUNG, Seoul (KR)

(21) Appl. No.: 17/285,472

(22) PCT Filed: Oct. 23, 2019
(86) PCT No.: PCT/KR2019/013966

§ 371 Date: Apr. 15, 2021

(30) Foreign Application Priority Data
Oct. 23, 2018 (KR) 10-2018-0126481

(51) Int. Cl. G06Q 30/06; G06F 16/951

(52) U.S. Cl. CPC G06Q 30/0631; G06F 16/951; G06Q 30/0627; G06Q 30/0643

(57) ABSTRACT

The present invention relates to a method for recommending a coordination fashion item in a service server and the method includes generating a product database by extracting and indexing a feature and/or a label of explaining contents of a product which is available in an online market based on an image of the product; generating a style database for a style image in which a person wears a plurality of fashion items; extracting a search target fashion item from a query when the query for an image displayed on a user device is received and searching for an item similar to the fashion item from the style database based on an image similarity; determining an item in a category different from the similar item from the style image from which the similar item is searched as a coordination item; and searching for the product database for the coordination item based on an image similarity and determining a product similar to the coordination item as a recommendation product.

### BACKGROUND OF THE INVENTION

### Field of the Invention

The present disclosure relates to a method for recommending a style related to fashion items and more particularly, to a product recommendation system which defines a style such as a characteristic, a feeling, or trends of a single fashion item or a combination of a plurality of fashion items in advance and recommends a coordination product to a user based on the style.

### Description of the Related Art

In the background of the recently increased wired/wireless internet environment, online commerce such as promotion or sales is being actively performed. With regard to this, when buyers find a product that they like while searching for magazines, blogs, or Youtube videos on desktops or mobile terminals connected to the Internet, the buyers search for a product name, which leads to a purchase. For example, the name of the bag that a famous actress carried at an airport or a name of a baby product from an entertainment program is ranked at the top of real-time search query rankings of portal sites. However, in that case, there is an inconvenience that the user needs to search for a product name, a manufacturer, and a sales location by opening a separate web page for search, and the user is not able to easily search unless the user already knows clear information about them.

In the meantime, sellers spend a lot of money on media sponsorship, recruitment of online user's review, or the like for product promotion as well as commercial advertisements. This is because word of mouth on online acts as an important variable in product sales in recent years. However, in many cases, shopping information such as product names or sales locations cannot be disclosed despite the spending of promotion cost. This is because media viewer's prior approval for exposure of product names cannot be obtained individually so that indirect advertising issues may be caused.

As described above, there is a need for both the users and the sellers to provide shopping information about online product images in a more intuitive user interface (UI) environment.

### CITATION LIST

### Patent Literature

Patent Literature 1: Korean Registered Patent Publication No. 10-1511050 (Apr. 6, 2015)

### SUMMARY OF THE INVENTION

An object of the present disclosure is to provide a method of defining a plurality of styles about look-and-feel such as appearances or feelings of a fashion item and trends and recommending a product to a user based on the style. Another object of the present disclosure is to provide a method of recommending not only a single item requested to be searched by a user but also another item which is well matched to the item based on the style.

The present invention relates to a method for recommending a coordination fashion item in a service server and the method includes generating a product database by extracting and indexing a feature and/or a label of explaining contents of a product which is available in an online market based on an image of the product; generating a style database for a style image in which a person wears a plurality of fashion items; extracting a search target fashion item from a query when the query for an image displayed on a user device is received and searching for an item similar to the fashion item from the style database based on an image similarity; determining an item in a category different from the similar item from the style image from which the similar item is searched as a coordination item; and searching for the product database for the coordination item based on an image similarity and determining a product similar to the coordination item as a recommendation product.

### BRIEF DESCRIPTION OF THE DRAWINGS

FIG. 1 is a flowchart for explaining a process of recommending a product to a user based on a style according to an exemplary embodiment of the present disclosure;

FIG. 2 is a flowchart for explaining a process of configuring a product database according to an exemplary embodiment of the present disclosure; and

FIG. 3 is a flowchart for explaining a process of configuring a style database according to an exemplary embodiment of the present disclosure.

### DETAILED DESCRIPTION OF THE PREFERRED EMBODIMENTS

The present invention is not limited to the following description of the exemplary embodiments, and it is obvious that various modifications may be applied without departing from the technical gist of the present disclosure. When the exemplary embodiment is described, a technology which is widely known in the technical field of the present invention and is not directly related to the technical gist of the present invention will not be described.

Hereinafter, even though it is assumed that a user device on which product information is displayed is a mobile device, the present invention is not limited thereto. That is, the user device of the present invention may be understood as a concept including all types of electronic devices which can request for search and display advertisement information, such as a desktop, a smart phone, or a tablet PC.

Further, it should be noted that the concept of the product in the present specification is not limited to tangible goods. That is, the product in the present specification needs to be understood as a concept including not only tangible goods, but also intangible services which can be sold.

Moreover, in the present specification, the term of a displayed page in a user device (in an electronic device) may be understood as a concept including a screen which is loaded in an electronic device so as to be immediately displayed on a screen in accordance with the scrolling of the user and/or contents in the screen. For example, on the display of the mobile device, an entire execution screen of an application which extends in a horizontal or vertical direction to be displayed according to the scrolling of the user may be included in the concept of the page and a screen during a camera roll may also be included in the concept of the page.

In the meantime, in the accompanying drawings, like reference numerals denote like components. In the accompanying drawings, some components may be exaggerated, omitted, or schematically illustrated. This is to clearly explain the gist of the present disclosure by omitting a redundant description which is not related to the gist of the present invention.

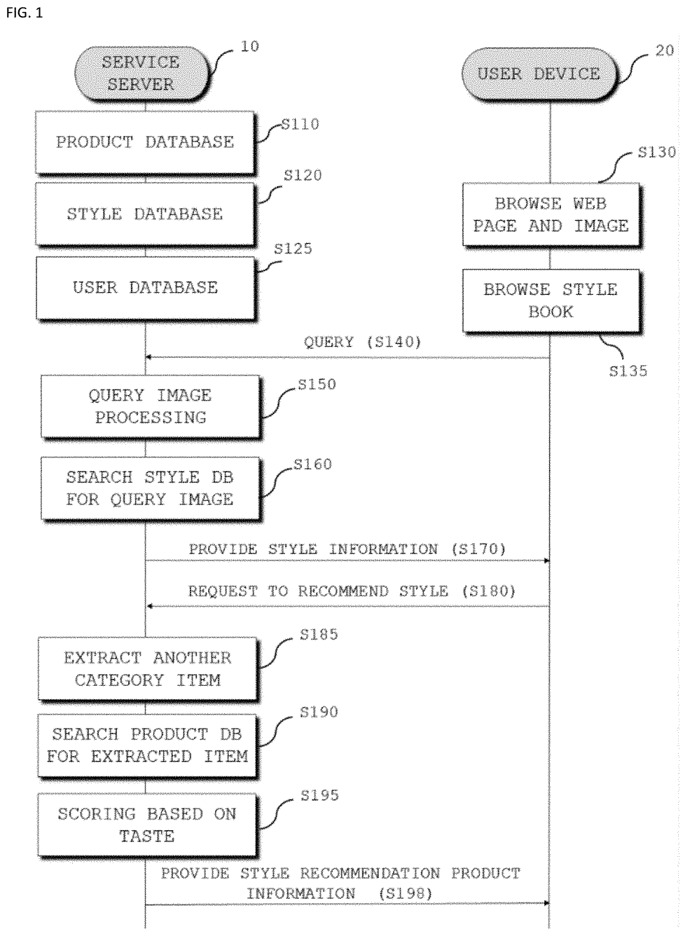

FIG. 1 is a flowchart for explaining a process of recommending a product to a user based on a style according to an exemplary embodiment of the present disclosure.

According to an exemplary embodiment of the present disclosure, a user-customized product recommendation service based on user's taste and style may be provided. For example, when a user takes a picture of a new white bag and requests another item which matches well with the bag, a service server may propose a product similar to a one-piece dress based on a photograph on which the one-piece dress is matched with a similar white bag, among photographs collected from fashion magazines, as a coordination item.

In the above example, when the service server receives a query of requesting style recommendation for a white bag, the service server recommends an item of a one-piece dress category which matches well with the white bag and satisfies a user's taste by referring to a previously generated style database, product database, and user database and provides online market information of the recommended one-piece dress together.

To be more specific, when a user specifies a specific fashion item and inquiries about the fashion item, the service server may search for a style database based on an image similarity of an object first and then determine an item similar to the query item. Thereafter, the service server may identify other items which are matched with the similar item from the image included in the style database and reflect user taste information to determine a coordination item from other items.

Thereafter, the service server may search for a product database based on an image similarity with respect to the coordination item to determine a recommendation product by setting a priority according to the user taste information.

In steps 110 to 130, the service server according to the exemplary embodiment of the present invention may configure a database which becomes a basis for product recommendation. The database may include a product information database, a style database, and a user database, and the service server may perform a function of searching for a query by referring to the databases and determining a recommendation product.

The product database may include detailed product information such as a country of origin, a size, a sales location of products which are sold in the online market and shots of the product being worn. Moreover, the style database may include information about a fashion image which may be referenced for fashion styles or coordination of a plurality of items, among images which are collected on the web. In the meantime, the user database may include information for estimating a user's taste, such as purchase data or browsing time data of the user. Further, the user database may include information about a user's body type and information about a price range, a purpose, and a brand preferred in online shopping for fashion items.

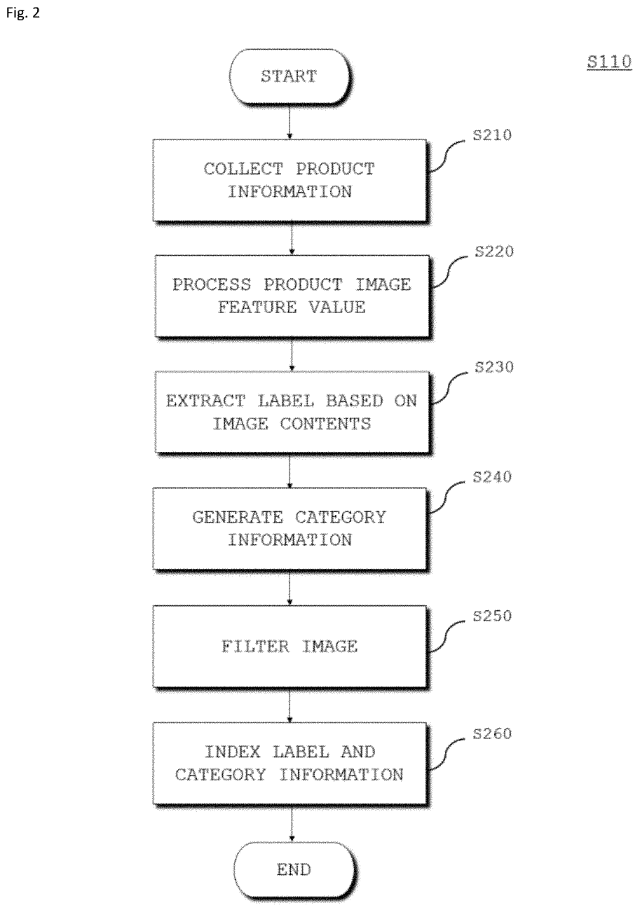

Specifically, the product database according to the exemplary embodiment of the present invention configures product information based on an image of the product (step 110). The generation of product database according to the exemplary embodiment of the present invention will be described in detail below with reference to the accompanying FIG. 2.

In the meantime, the service server 10 according to the exemplary embodiment of the present invention may configure a style database which becomes a basis for style recommendation (step 120).

The style database may include an image in which a plurality of fashion items is coordinated to be well matched (hereinafter referred to as a style image in the present specification), among images collected online and classification information for the style image. The style image according to the exemplary embodiment of the present invention is image data which is generated by coordinating a plurality of fashion items in advance by professionals or semi-professionals and may include a fashion catalog which can be collected on the web, fashion magazine photo images, fashion show shooting images, idol costume images, costume images of a specific drama or movie, costume images of SNS or blog celebrities, street fashion images of a fashion magazine, or an image in which a fashion item is coordinated with the other item for sale of the fashion item as examples.

The style image is stored in the style database according to the exemplary embodiment of the present invention to be used to determine another item which is well matched with the specific item. By doing this, the style image may be utilized as a reference material to allow a computer to generally understand a human's feeling “well-matched”.

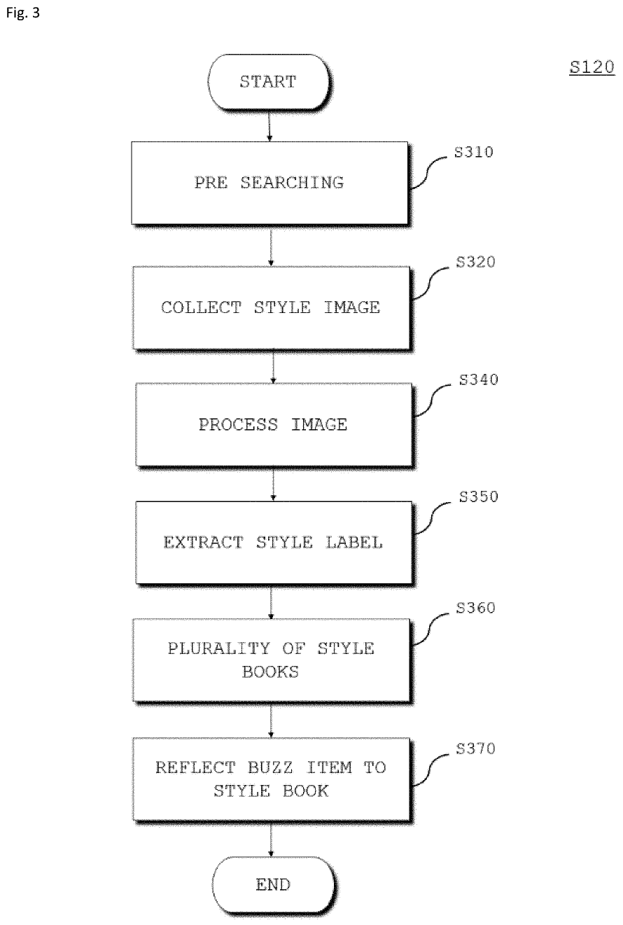

A method for generating a style database according to the exemplary embodiment of the present disclosure will be described below in the description of the accompanying FIG. 3.

FIG. 3 is a flowchart for explaining a process of configuring a style database according to an exemplary embodiment of the present disclosure.

In step 310, the service server may collect style images online. For example, the service server may collect a web address list of fashion magazines, fashion brands, drama production companies, entertainment agencies, SNS, online stores, and the like and collect image information included in a website by checking a website and tracking a link.

In the meantime, the service server according to the exemplary embodiment of the present invention may not only collect and index images from websites of fashion magazines, fashion brands, drama production companies, entertainment agencies, SNS, online stores, and the like, but also may be separately provided with image information together with index information from affiliated partners.

In step 320, the service server may filter an image which is not appropriate for style recommendation, among the collected images.

For example, the service server may leave only images including a person-shaped object and a plurality of fashion items among the collected images and filter the remaining images.

The style image is used to determine another item which may be coordinated with the query item, so it is appropriate to filter an image for a single fashion item. Further, when the database is configured with images in which a person is directly wearing the plurality of fashion items, it may be more useful than being configured with images of the fashion item itself. Accordingly, the service server according to the exemplary embodiment of the present invention may determine a style image included in the style database by leaving only the image which includes a person-shaped object and a plurality of fashion items and filtering the remaining images.

Thereafter, the service server may process a feature of the fashion item object image included in the style image (step 340).

To be more specific, the service server extracts an image feature of a fashion item object included in the style image and represents the feature information with a vector value to generate a feature value of the fashion item object and index the feature information of the images.

Moreover, the service server according to the exemplary embodiment of the present invention may extract a style label from the style image and cluster style images based on the style label (step 350).

It is appropriate to extract a style label about look-and-feel of an appearance or feeling of the fashion item or trends. According to a preferred embodiment of the present invention, a label about a feeling which can be felt by a person is extracted from an appearance of a single item or a coordination of a plurality of items included in the style image and may be utilized as a style label. For example, examples of the style label may include a celebrity look, a magazine look, a summer look, a feminine look, a sexy look, an office look, a drama look, a Chanel look, or the like.

According to an exemplary embodiment of the present invention, the service server may define a style label in advance and generate a neural network model which learns a feature of the image corresponding to the label to classify objects in the style image and extract a label for a corresponding object. At this time, the service server may assign a corresponding label to an image matching to a specific pattern with a predetermined probability by means of a neural network model which learned a pattern of an image corresponding to each label.

According to another exemplary embodiment of the present invention, the service server learns features of the image corresponding to each style label to form an initial neural network model and applies a large number of style image objects to more delicately expand the neural network model.

In the meantime, according to still another exemplary embodiment of the present invention, the service server may apply the style images to a neural network model formed with a layered structure formed by a plurality of layers without separately learning the label. Moreover, the service server may assign a weight to the feature information of the style image in accordance with a request of a corresponding layer, cluster the product images using processed feature information, and assign a label which is interpreted posteriorly as a celebrity look, a magazine look, a summer look, a feminine look, a sexy look, an office look, a drama look, a Chanel look, or the like to a clustered image group.

In step 360, the service server may cluster style images using the style label and generate a plurality of style books. This is provided to the user as a reference. The user may find a favorite item while browsing a specific style book among a plurality of style books provided by the service server and request searching for product information about the corresponding item.

In the meantime, in step 370, the service server may classify items having a higher appearance rate such as white shirts, jeans, and black skirts, in advance.

For example, the jeans are a basic item in fashion so that an appearance rate in the style image is very high. Accordingly, no matter what the user inquiries about, the probability of matching jeans as a coordination item will be much higher than other items.

Accordingly, the service server according to the exemplary embodiment of the present invention may classify an item having a very high appearance rate in the style image as a buzz item in advance and generate style books with different versions such as a version including a buzz item and a version which does not include a buzz item.

According to another exemplary embodiment of the present invention, the buzz item may be classified by reflecting time information. For example, when a trend cycle of a fashion item is considered, items which are popular for a short time of one or two months and then disappear, popular items which return every season, and items which are constantly popular for a predetermined period may be considered. Accordingly, when time information is reflected to classification of the buzz item, if an appearance rate of a specific fashion item for a predetermined period is very high, the item may be classified as a buzz item together with the information about the corresponding period. When the buzz item is classified as described above, in a subsequent item recommending step, the item may be recommended by considering whether an item to be recommended is in trend or is regardless of the trend.

Returning to the description of FIG. 1, in step 125, the service server may generate the user database. The user database may include user identification information, user behavioral information for estimating a user's taste, and user taste estimated from the behavioral information, and user taste information which is directly received from a user device.

For example, the service server provides inquiries about an age, a gender, a job, a fashion field of interest, a possessed item of the user to the user device and receives a user input about the inquiries to generate user taste information and reflect the user taste information to the user database.

Moreover, the service server combines user behavioral information to estimate the user's taste such as a time when the user browses an arbitrary style book provided through an application according to an exemplary embodiment of the present invention, item information that a tag for likes is generated, a query item, fashion item information purchased through the application or another application, and time information when the information is generated to generate taste information about a style that the user is interested at the corresponding point of time and reflect the taste information to the user database.

Moreover, the service server may generate body type information of the user and reflect the body type information to the user database.

For example, when the user device generates body images obtained by photographing a body of the user at a plurality of angles to transmit the body images to the service server, the service server may generate a user body type model from a machine learning framework which learned a human body feature with a large number of body images. The user body type model may include not only size information of each part of the user body, but also information about a proportion of each part of the user body and a skin tone.

According to another exemplary embodiment of the present invention, the service server may generate user's preference information about the fashion item and reflect the preference information to the user database. The preference information may include information about a user's preferred price, a preferred brand, and a preferred purpose. For example, when the fashion item is being browsed or purchased by means of an online market by the user device, the service server may reflect different weights to the browsing or the purchase to generate information about the preferred price, the preferred brand, and the preferred purpose and reflect the information to the user database.

In particular, the service server according to the exemplary embodiment of the present invention estimates a “taste” of the user corresponding to feeling of human and generates the estimated taste information to be recognizable by a computer to reflect the information to the user database.

For example, the service server may extract a label for estimating a taste of the user from the behavioral information of the user. The label may be extracted as meanings of fashion items included in the user's behavioral information such as style books browsed by the user, items that a tag for likes is generated, query items, and purchased items. Moreover, the label may be generated as information about look-and-feel such as appearances or feeling of fashion items included in the user behavioral information and trends.

The label generated from the user behavioral information is applied with a weight according to the user's behavior and the service server may generate user taste information estimating a user's taste by combining it and store the user taste information in the user database. The user taste information, the user body type information, and the user preference information included in the user database may be used to set an exposure priority of a recommendation item or a recommendation product.

The user who browses a webpage or an arbitrary image in step 130 may transmit a query for inquiring about product information about a specific fashion item or a query for inquiring about a coordination item which may be well matched with the item to the service server (step 140).

For example, the user may transmit a query for requesting product information of a specific fashion item or requesting to recommend a coordination item which may be well matched therewith to the service server while browsing an arbitrary online shopping mall.

As another example, the user may take a picture of a specific fashion item offline to transmit a query for requesting product information of the corresponding fashion item or requesting to recommend a coordination item which may be well matched therewith to the service server.

In the meantime, the user device may transmit a query for inquiring about product information of a specific item or a query for inquiring about another coordination item which may be well matched therewith but is not included in a style book to the service server (step 140) while browsing the corresponding style book provided through an application according to an exemplary embodiment of the present invention (step 135).

The user device which transmits the query may transmit, for example, a query including a record log of the web browser to the service server. The record log may include a browsing history of the web browser and URL information of a web page which is executed at a corresponding point of time. Moreover, the user device may extract images, videos, and text data included in the URL of the webpage and transmit extracted data as a query. When the URL, text, image, or video data cannot be extracted, the user device may extract a screenshot to transmit the screen shot as the query.

Specifically, the user device according to the preferred embodiment of the present invention may transmit an image displayed at the corresponding point of time as the query. For example, the user device may extract an object which can be searched from an image included in the style book received from the service server to transmit the object as the query.

The user device may not only transmit the query without having the user's separate search request, but also transmit the query based on the user's search request.

For example, the user device may transmit the query based on the reception of the search request of the user. When the user inquiries about a coordination item for a fashion item included in an image being browsed, the user device may extract an object in the image which is requested for search to transmit the object as the query. Further, the user device may specify a searchable object in the displayed image in advance and transmit a query about an object for which a user's choice input is received.

To this end, the user device may operate so as to determine whether an object in a predetermined category is included in the displayed image and specify an object to display a search request icon for the corresponding object.

According to the above-described exemplary embodiment, the user device may operate to specify an object for a fashion item in the image included in the style book to transmit only a query about the specified object. Moreover, when objects for a plurality of fashion items are included in the image, the user device may operate so as to specify individual objects and transmit only a query for an object selected by the user.

In the meantime, in step 150, the service server according to the exemplary embodiment of the present invention may process a fashion item object included in the received query and search for a style database based on an image similarity (step 160).

To be more specific, an advertising service server according to an exemplary embodiment of the present invention may receive a query image and separately recognize the objects when a plurality of objects is included in the query image. In the query received from the user device, a search target object may be specified.

Thereafter, the service server may process an image object which is specified as a search target. By doing this, a similar item may be searched from the style database based on the contents of the query image.

To this end, the service server may extract features of the search target image object and index specific information of the images for the purpose of the searching efficiency. A more detailed method may be understood by referring to a product image processing method which will be described below in the description of FIG. 2.

Moreover, the service server according to the exemplary embodiment of the present invention may apply a machine learning technique used to build a product image database to be described below in the description of FIG. 2 to the processed search target object image to extract a label about the meaning of the search target object image and/or category information. The label may be represented as an abstracted value, but may also be represented as a text form by interpreting the abstracted value.

For example, the service server according to an exemplary embodiment of the present invention may extract labels about a woman, a one-piece dress, sleeveless, linen, white, and a casual look from the query object image. In this case, the service server may utilize a label about woman and one-piece dress as category information of the query object image and utilize a label about a sleeveless, linen, white, and a casual look as label information for explaining a characteristic of the object image other than the category.

Thereafter, the service server may search for a style database based on a similarity of the query object image. By doing this, an item similar to the query image is searched from the style database to identify another item which is matched with a similar item in the style image. For example, the service server may calculate similarities of feature values of the query object image and fashion item object images included in the style image and identify an image with a similarity in a predetermined range.

Moreover, the service server according to the exemplary embodiment of the present invention may process a feature value of the query image by reflecting a weight requested by a plurality of layers of an artificial neural network model for machine learning configured for the product database of step 110, select at least one of fashion item groups included in the style book having a distance in a predetermined range from the query image, and determine items belonging to the group as similar items.

In the meantime, according to a preferred embodiment of the present invention, the service server may determine a similar item by searching for the style database based on the similarity of the query image and may use the label extracted from the image and category information to increase an accuracy for image search.

For example, the service query may calculate a similarity of feature values of the query image and the style database image and determine a similar item by excluding products whose label and/or category information does not match the label and/or the category information of the query image among products having a similarity in a predetermined range or higher.

As another example, the service server may calculate an item similarity only in a style book having label and/or category information which matches the label and/or category information of the query image.

For example, the service server according to the exemplary embodiment of the present invention may extract a style label from the query image and specify a similar item based on the image similarity to the query in the style book matching the label. The service server may also specify a similar item based on the image similarity to the query image in the style database without extracting a separate label from the query image.

For example, when there is a leaf pattern one-piece dress in an image included in the query, the service server may extract a label of tropical from the query. Thereafter, the service server may specify a similar item having a similarity in a predetermined range to the leaf pattern one-piece dress from the style book clustered with a label of tropical (step 160).

Thereafter, the service server may provide a style image in which a similar item searched from the style book is included and a similar item is coordinated with other fashion items to the user device (step 170). In the above-described example with the leaf pattern one-piece dress, a style image in which a straw hat or a rattan bag is coordinated with the leaf pattern one-piece dress may be provided to the user.

In step 180, the user device may browse a style image, request another item recommendation for coordination with the query item, or request product information about an item in another category included in the style image.

In the meantime, steps 170 and 180 in FIG. 1 are not essential processes and may be omitted. That is, according to an exemplary embodiment of the present invention, when the user device transmits a query, the service server may provide product information of another category which is well matched with the query as a response of the query. That is, even though the user does not transmit a request for a separate coordination item recommendation, the service server may transmit product information of a coordination item which is coordinated with the query item.

In the meantime, when an item similar to the query item is searched from the style database, in order to recommend a coordination item, the service server may identify a fashion item in another category which is coordinated with the similar item to be included in a style image (step 185).

Since “well-matched” with an arbitrary item is about a feeling of human, in order to allow a computer to recommend another “well-matched” item with an arbitrary item without intervention of the person, a machine learning framework which learned the matching of a plurality of fashion items may be necessary. To this end, the service server according to the exemplary embodiment may collect style images in which a plurality of fashion items is coordinated by professionals or semi-professionals to be worn on a person and generate the style images as a style database. Moreover, the service server applies the style database to the machine learning framework to train the framework. For example, the machine learning framework which learns a large number of style images in which a blue shirt is matched with a brown tie may recommend a brown tie as a coordination item for a query for a blue shirt.

Moreover, the service server may search for a fashion item inquired by the user from the style database based on the image similarity and consider a fashion item in another category which is matched with the similar item in a style image including a similar item as a recommendation item. This is because the service server according to an exemplary embodiment of the present invention is trained to consider that another item which is matched with the query item in the style image is well matched.

When the recommendation item is determined using the style database, the service server may search for the recommendation item from the product database based on the similarity of the image contents (step 190). This is because since the style database is an image database for referring to the combination of the plurality of fashion items, details such as a price, a sales location, and materials of each fashion item are not included.

For example, in the above-described example of the leaf pattern one-piece dress query, even though an image in which a straw hat and a rattan bag are coordinated with the leaf pattern one-piece dress is searched from the style database, the straw hat and the rattan bag may not be available products at the corresponding point of time, but may be a private collection of a stylist. Alternatively, the style image is a fashion catalog of a famous designer so that the straw hat and the rattan bag may be very expensive products.

In this case, the user may wonder if there is a similar product which can be purchased online and has a typical price. Accordingly, the service server according to the exemplary embodiment of the present invention may search for an item similar to the query item from the style database, determine an item in another category matched with the similar item as a recommendation item, and search for an item similar to the recommendation item from the product database to provide product information about the recommendation item.

To be more specific, the service server may search for a recommendation item determined in the style database from the product database based on the image similarity (step 190).

To this end, the service server may extract a feature of the recommendation item object included in the style image and index specific information of the images for the searching efficiency, and a more detailed method may be understood by referring to the method of processing the above-described product image.

The service server according to the exemplary embodiment of the present invention may search for the product database based on the similarity of the object image. For example, the service server may calculate a similarity of feature values of the recommendation item image and the product image included in the product database and determine a product with a similarity in the predetermined range as a recommendation product.

Moreover, the advertising service server according to the exemplary embodiment of the present invention may process a feature value of the recommendation item image by reflecting a weight requested by a plurality of layers of an artificial neural network model for machine learning configured for the product database, select at least one of product groups having a distance value in a predetermined range, and determine products belonging to the group as a recommendation product.

Moreover, the service server according to another exemplary embodiment of the present invention may specify a recommendation product based on a label extracted from the recommendation item object.

For example, when a woman's top, a blouse, white, and stripe patterns are extracted as label information of the object extracted from the recommendation item image, the service server may calculate the similarity with the search target object image only for a product group having the woman's top as higher category information.

As another example, the service server may set products having a similarity higher than a predetermined range as a recommendation candidate product and exclude products whose sub-category information is not a blouse from the recommendation candidate product. In other words, products whose sub-category information is indexed as a blouse may be selected as an advertising item.

As another example, the label information extracted from the object image of the recommendation item is a woman's top, a blouse, long sleeve, lace, and collar neck, the service server may calculate an image similarity with the recommendation item only for the product group having a woman's top, a blouse, long sleeve, lace, and collar neck as a label in the product database.

When the recommendation product is determined, in step 195, the service server may determine an exposure priority by reflecting user taste information. For example, when the taste information of the user gives a weight to the office look, the priority is calculated by applying a weight to the office look label and the recommendation product information may be provided according to the calculated priority (step 198).

In the meantime, FIG. 2 is a flowchart for explaining a process of configuring a product information database according to an exemplary embodiment of the present disclosure.

In step 210 of FIG. 2, the service server may collect product information.

The service server may collect not only product information of online markets which are affiliated in advance, but also product information about products which are being sold in an arbitrary online market. For example, the service server includes a crawler, a parser, and an indexer to collect web documents of online stores and access text information such as product images, product names, and prices included in the web documents.

For example, the crawler may transmit data related to the product information to the service server by collecting a web address list of the online markets and checking the website to track a link. At this time, the parser interprets the web documents collected during the crawling process to extract product information such as product images, product prices, and product names included in the page and the indexer may index the corresponding position and the meaning.

In the meantime, the service server according to the exemplary embodiment of the present invention may not only collect and index product information from a web site of an arbitrary online store, but also be provided with product information with a predetermined format from the affiliated market.

In step 220, the service server may process the product image. By doing this, the recommendation item may be determined based on whether the product image is similar, without depending on the text information such as a product name or a sales category.

According to an exemplary embodiment of the present invention, the recommendation item may be determined based on whether the product image is similar, but the present invention is not limited thereto. The product image may utilize not only the product image, but also the product name or the sale category as an independent query or an auxiliary query in accordance with the implementation. To this end, the service server may generate a database by indexing text information such as a product name and a product category in addition to the product image.

According to a preferred embodiment of the present invention, the service server may extract a feature of the product image and index feature information of the images for the searching efficiency.

To be more specific, the service server may detect a feature area of the product images (interest point detection). The feature area refers to a main area which extracts a descriptor for a feature of an image, that is, a feature descriptor, to determine whether the images are the same or similar.

According to the exemplary embodiment of the present invention, the feature area may be an outline included in the image, a corner among the outlines, a blob which is distinguished from the surrounding area, an area which is invariant or covariable according to the transformation of the image, or an extremum point which is darker or brighter than the surrounding area and may be a patch (a piece) of the image or the entire image.

Moreover, the service server may extract a feature descriptor from the feature area (descriptor extraction). The feature descriptor represents features of the image as a vector value.

According to an exemplary embodiment of the present disclosure, the feature descriptor may be calculated using a position of a feature area with respect to the corresponding image, a brightness, a color, a sharpness of the feature area, a gradient, a scale, or pattern information. For example, the feature descriptor may be calculated by converting the brightness value of the feature area, a change value of the brightness, or a distribution value into a vector.

In the meantime, according to the exemplary embodiment of the present invention, the feature descriptor for the image may be represented not only as a local descriptor based on a feature area as described above, but also as a global descriptor, a frequency descriptor, a binary descriptor, or a neural network descriptor.

To be more specific, the feature descriptor may include a global descriptor which converts the entire image or a section obtained by dividing the image according to arbitrary criteria, or a brightness, a color, a sharpness, a gradient, a scale, or pattern information of each feature area into a vector value to be extracted.

For example, the feature descriptor may include a frequency descriptor which converts and extracts the number of times that specific descriptors classified in advance are included in the image or the number of times of including a global feature such as a color table which is defined in the related art into a vector value, a binary descriptor which extracts whether each descriptor is included or whether a size of each element value which configures the descriptor is larger or smaller than a specific value in the unit of bit and then converts into an integer form and uses it, and a neural network descriptor which extracts image information used to learn or classify from the layer of the neural network.

Moreover, according to an exemplary embodiment of the present invention, the feature information vector extracted from the product image may be converted into that of a lower dimension. For example, the feature information extracted by means of the artificial neural network corresponds to 40,000 dimensions of high dimensional vector information and may be appropriately converted into a lower dimensional vector in an appropriate range, in consideration of the resource requested for the searching.

The feature information vector may be converted using various dimensional reduction algorithms such as PCA or ZCA, and the feature information converted into a lower dimensional vector may be indexed with the corresponding product image.

Moreover, the service server according to the exemplary embodiment of the present invention applies a machine learning technique based on the product image to extract a label with respect to the meaning of the corresponding image. The label may be represented as an abstracted value, but may also be represented as a text form by interpreting the abstracted value (step 230).

To be more specific, according to a first exemplary embodiment of the present invention, the service server defines a label in advance and generates a neural network model which has learned a feature of the image corresponding to the label to classify objects in the product image and extract a label for a corresponding object. At this time, the service server may assign a corresponding label to an image matching to a specific pattern with a predetermined probability by means of a neural network model which has learned a pattern of an image corresponding to each label.

According to a second exemplary embodiment of the present invention, the service server learns features of the image corresponding to each label to form an initial neural network model and applies a large number of product image objects to more delicately expand the neural network model. Moreover, when the corresponding product is not included in any group, the service server may generate a new group including the corresponding product.

According to the first exemplary embodiment and the second exemplary embodiment, the service server may define a label which may be utilized as meta information about a product, such as a woman's bottom, a skirt, a one-piece dress, short sleeve, long sleeve, a shape of a pattern, a material, a color, or an abstract feeling (pure, chic, vintage, or the like) in advance, generates a neural network model which has learned the feature of an image corresponding to the label, and applies the neural network model to a product image of an advertiser to extract a label for the product image to be advertised.

In the meantime, according to a third exemplary embodiment of the present invention, the service server may apply the product images to a neural network model formed with a layered structure formed by a plurality of layers without separately learning the label. Moreover, the product images may be clustered by assigning a weight to the feature information of the product image according to the request of the corresponding layer and using processed feature information.

In this case, in order to identify which attribute of the feature value is used to cluster the corresponding images, that is, in order to connect the clustering result of the images to the conception which can be actually recognized by the human, additional analysis may be necessary. For example, when the service server classifies the products into three groups by means of the image processing and extracts a label A for a feature of a first group, a label B for a feature of a second group, and a label C for a feature of a third group, it is necessary to posteriorly interpret that A, B, and C mean a woman's top, a blouse, and a check pattern, respectively.

According to the third exemplary embodiment, the service server may assign a label which may be posteriorly interpreted as a woman's bottom, a skirt, a one-piece dress, short sleeve, long sleeve, a shape of pattern, a material, a color, and an abstract feeling (pure, chic, vintage, or the like) to the clustered image group and extract labels assigned to the image group to which individual product images belong as a label of the corresponding product image.

In the meantime, the service server according to the exemplary embodiment of the present invention may represent the label extracted from the product image as a text and a text type label may be utilized as tag information of the product.

In the related art, the tag information of the product is subjectively directly assigned by a seller so that it is inaccurate and the reliability is degraded. The product tag which is subjectively assigned by the seller acts as a noise to lower the searching efficiency.

As described in the exemplary embodiment of the present invention, when the label information is extracted based on the product image and the extracted label information is converted into a text to be utilized as tag information of the corresponding product, the tag information of the product may be mathematically extracted without intervention of the human based on the corresponding product image so that the reliability of the tag information is increased and a searching accuracy is improved.

Moreover, in step 240, the service server may generate category information of the corresponding product based on the product image contents.

Even though in the example of FIG. 2, step 230 and step 240 are illustrated as separate steps, this is for the convenience of description and the present invention is not limited thereto. According to the exemplary embodiment of the present invention, even though the label information and the category information may be separately generated, the label information may be utilized as category information or the category information may be utilized as label information.

For example, when a woman, a top, a blouse, linen, stripe, long sleeve, blue, and an office look are extracted as a label for an arbitrary product image, the service server may utilize the label for a woman, a top, and a blouse as the category information of the corresponding product and utilize the label for linen, stripe, long-sleeve, blue, and an office look as label information for explaining a characteristic of the product other than the category. Alternatively, the service server may index the label and the category information to the corresponding product without distinguishing the label from the category information (step 260).

At this time, the category information and/or the label of the product may be utilized as a parameter for increasing a reliability for image search.

Moreover, the service server according to another exemplary embodiment of the present invention may determine a recommendation item based on the label without separately calculating the image similarity.

In the meantime, the service server according to the exemplary embodiment of the present invention may filter collected product description images (step 250). By doing this, the product image database may be configured by excluding the product image which may act as a noise for image search.

To be more specific, the service server may determine whether to filter the product image by comparing a label extracted from the product image and a category and/or tag information which is directly assigned by the seller.

According to the exemplary embodiment of the present invention, when there is a plurality of images for a specific product and a label extracted from one of the images is different from a category which is assigned for the corresponding product by the seller, the corresponding image or a specific object in the corresponding image may be filtered in the database.

For example, it is considered that there are first to third product images for product A, a label of (a woman's top and a jacket) is extracted from the first product image, labels of (a woman's top and a jacket) and (sunglasses, round) are extracted from the second product image, and a label of (sunglasses, round) is extracted from the third product image. At this time, when the sales category of the product A is “sunglasses”, the service server may configure the product image database only with the second and third product images excluding the first product image.

The filtering is performed to reduce the noise of image search. In the above example, the product A is actually about sunglasses. When the database is configured with all the first to third product description images, even though the query image is a jacket, it is determined to be similar to the first product image to determine a product A for the sunglasses as an advertising item. Accordingly, the database is built by filtering a product image which may degrade a searching accuracy.

According to an exemplary embodiment of the present disclosure, a user-customized product recommendation service based on user's taste and style may be provided. Moreover, according to the exemplary embodiment of the present invention, label information is extracted based on a product image, and the extracted label information is converted into a text to be utilized as tag information of the corresponding product. By doing this, the tag information of the product may be mathematically extracted without intervention of the human so that the reliability of the tag information is increased and the searching accuracy is improved.

The exemplary embodiments disclosed in the present specification and the drawings merely provide a specific example for easy description and better understanding of the technical description of the present disclosure, but are not intended to limit the scope of the present disclosure. It is obvious to those skilled in the art that modifications based on the technical spirit of the present disclosure, other than the disclosed exemplary embodiment are allowed.

What is claimed is:

1. A method for recommending a coordination fashion item in a service server, the method comprising:
generating a product database by extracting and indexing a feature and/or a label of explaining contents of a product which is available in an online market based on an image of the product;
generating a style database for a style image in which a person wears a plurality of fashion items;
extracting a search target fashion item from a query when the query for an image displayed on a user device is received and searching for an item similar to the fashion item from the style database based on an image similarity;
determining an item in a category different from the similar item from the style image from which the similar item is searched as a coordination item; and
searching for the product database for the coordination item based on the image similarity and determining a product similar to the coordination item as a recommendation product.

2. The fashion item recommending method according to claim 1, wherein the style image is image data generated by coordinating a plurality of fashion items by a professional or a semi-professional and performs a function of allowing a computer to learn a feeling of a human for the coordination of the plurality of fashion items.

3. The fashion item recommending method according to claim 2, further comprising:
before the searching,
generating a user database including at least one of user identification information, user behavioral information for estimating a user's taste, user taste information estimated from the behavioral information, and user taste information which is directly received from a user device, and
after the determining,
setting an exposure priority of the recommendation product using the user taste information,
wherein the user taste information includes body type information of the user, and information about a price, brand, or purpose preferred by the user.

4. The fashion item recommending method according to claim 3, wherein the generating of a style database includes: generating the style database by extracting a style label which represents a feeling felt from an appearance of a single fashion item included in the style image or a coordination of the plurality of fashion items included in the style image by a human as computer recognizable data and indexing the style label information.

5. The fashion item recommending method according to claim 4, wherein the generating of a style database includes: clustering the style images using the style label and generating at least one style book for style images which share an arbitrary style label.

6. The fashion item recommending method according to claim 5, wherein the generating of a style database includes: classifying a fashion item whose appearance frequency in the style image is a predetermined rate or higher, as a buzz item; and
generating a style book including the buzz item and a style book excluding the buzz item.
